(19) United States
(12) Patent Application Publication
(10) Pub. No.: US 2013/0030971 A1
(43) Pub. Date: Jan. 31, 2013

(54) SYSTEMS AND METHODS FOR ALLOCATING FUNDS BETWEEN MULTIPLE BANKING PRODUCTS

(71) Applicants: Mitchell Roy Weiss, Dix Hills, NY (US); Andrew Adam Mintz, Livingston, NJ (US)

(72) Inventors: Mitchell Roy Weiss, Dix Hills, NY (US); Andrew Adam Mintz, Livingston, NJ (US)

(73) Assignee: REICH & TANG DEPOSIT SOLUTIONS, L.L.C., New York, NY (US)

(21) Appl. No.: 13/558,153

(22) Filed: Jul. 25, 2012

Related U.S. Application Data
(60) Provisional application No. 61/512,176, filed on Jul. 27, 2011.

(51) Int. Cl. G06Q 40/00

(52) U.S. Cl. 705/35

(57) ABSTRACT

An allocation of funds to multiple accounts is determined. Information about financial transactions is received from multiple sources, and the information is aggregated to determine a total amount of allocatable funds. The allocatable funds include posted interest either before or after a term deposit payment date. Respective deposit rules are determined for each of the multiple accounts. The multiple accounts include sub-accounts at the same bank, and the deposit rules include a limit based on FDIC insurance. The allocation of the allocatable funds to the multiple accounts is determined based on a priority hierarchy set to the multiple accounts. Funds are allocated such that each account or sub-account in the priority hierarchy is filled to its respective limit according to the respective deposit rules until the total amount of allocatable funds is allocated.

### CROSS-REFERENCE TO RELATED APPLICATION

This application claims priority to U.S. Provisional Application No. 61/512,176, filed Jul. 27, 2011, the contents of which are incorporated herein by reference.

### BACKGROUND

1. Field

Example aspects of the present invention generally relate to allocating funds between multiple banking products.

2. Related Art

Under a so-called “sweep program”, uninvested cash balances for which no interest is otherwise earned or paid are automatically swept into interest-bearing accounts such as money market mutual funds, an FDIC insured interest-bearing deposit account, or such other available sweep arrangements, until the balances are invested or otherwise used to satisfy obligations in connection with their account.

From a cyclical perspective, under certain market conditions it can be difficult to place large amounts of funds in a single account such as a Money Market Deposit Account (MMDA). For example, when the economy is weak, banks typically have excess funds which allows them to be more selective about whose deposits they take, the rate they pay on those deposits, and the amount of deposits they will take. This uncertainty makes broker-dealer businesses difficult to operate reliably, particularly if the sweep programs are not viable during a particular period of an economic cycle.

From a structural perspective, increasing regulatory scrutiny about funding sources and reliability can make certain types of accounts less interesting to depository institutions. Often, their asset-liability management committee “ALCO” issue policies requiring greater diversification of funding and greater reliability of funding through all market environments. Potential changes in regulatory standards can also make certain accounts unattractive because of the liquidity requirements associated with overnight funding.

From a supply perspective, both the use of FDIC insured programs and sweep programs continue to rise. Nevertheless, it is difficult to obtain a proper allocation of funds which can account for diverse accounts and account types. For example, while current bank systems ordinarily can manage allocating net transactions to a single account at a bank, the systems are not adapted to allocating funds to multiple sub-accounts at another bank or between different sub-account types (e.g., between MMDA's and term deposits).

### BRIEF DESCRIPTION

The example embodiments described herein address the foregoing by providing systems, apparatuses, methods, and computer program products for determining an allocation of funds to multiple accounts.

One example aspect provides systems, apparatuses, methods, and computer program products in which information about financial transactions is received from multiple sources over a communication network. The information is aggregated to determine a total amount of allocatable funds. The allocatable funds include posted interest. Respective deposit rules are determined for each of the multiple accounts. The multiple accounts include sub-accounts at the same bank, and the deposit rules include a limit based on FDIC insurance. The allocation of the allocatable funds to the multiple accounts is determined based on a priority hierarchy set to the multiple accounts, and funds are allocated such that each account or sub-account in the priority hierarchy is filled to its respective limit according to the respective deposit rules until the total amount of allocatable funds is allocated.

Another example aspect provides systems, apparatuses, methods, and computer program products in which a server receives part or all of an allocation of funds to multiple accounts. The server includes at least one processor communicatively coupled to a communication network. The server receives an allocation of allocatable funds over the network. The allocation of allocatable funds is determined by receiving information about financial transactions from multiple sources over the communication network, and aggregating the information to determine a total amount of allocatable funds. The allocatable funds include posted interest associated with the allocatable funds. The allocation is further determined by determining respective deposit rules for each of the multiple accounts, wherein the multiple accounts include sub-accounts at the same bank. The deposit rules include a limit based on FDIC insurance, and the allocation of the allocatable funds to the multiple accounts is determined based on a priority hierarchy set to the multiple accounts. Funds are allocated such that each account or sub-account in the priority hierarchy is filled to its respective limit according to the respective deposit rules until the total amount of allocatable funds is allocated.

Further features and advantages, as well as the structure and operation, of various example embodiments of the present invention are described in detail below with reference to the accompanying drawings.

### BRIEF DESCRIPTION OF THE DRAWINGS

The features and advantages of the example embodiments presented herein will become more apparent from the detailed description set forth below when taken in conjunction with the drawings.

FIGS. 1A to 1C are views for explaining an environment in which example embodiments of the invention may be practiced.

FIG. 2 is a flowchart diagram showing an exemplary procedure for sweeping allocatable funds into multiple accounts.

FIG. 3 is a flowchart diagram showing an exemplary procedure for allocation of funds amongst financial institutions.

FIG. 4 is a flowchart diagram showing another exemplary procedure for allocation of funds amongst financial institutions.

FIG. 5 is a flowchart diagram showing an exemplary procedure for determining an allocation of funds to multiple accounts.

FIG. 6 is a flowchart diagram showing an exemplary procedure for an interest posting process.

FIG. 7 is a block diagram of a special purpose computer in accordance with some of the example embodiments of the invention.

### DETAILED DESCRIPTION

### I. Overview

The example embodiments of the invention presented herein are directed to apparatuses, methods, and computer program products for allocating funds in an environment using banking products or services. This description is not intended to limit the application of the example embodiments presented herein.

### II. System

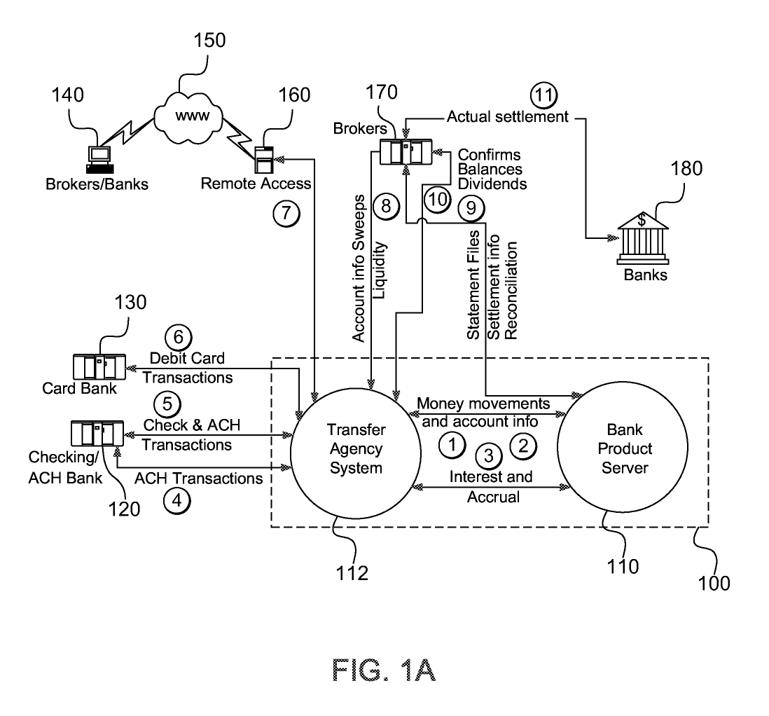

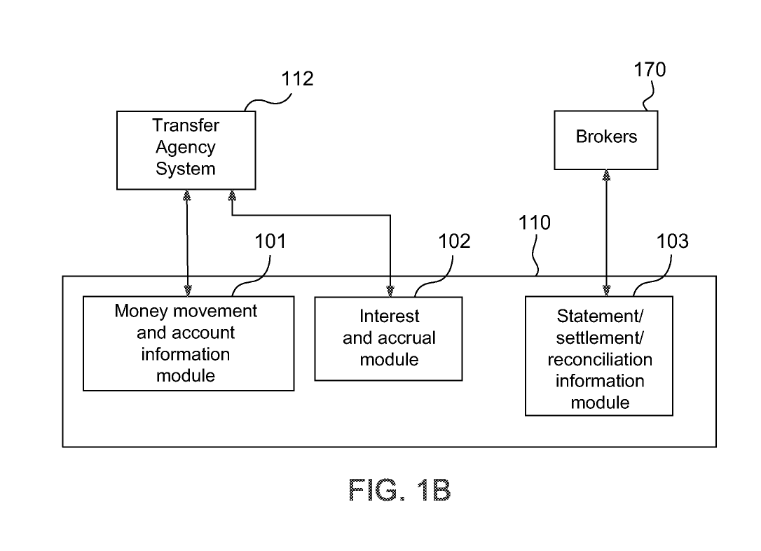

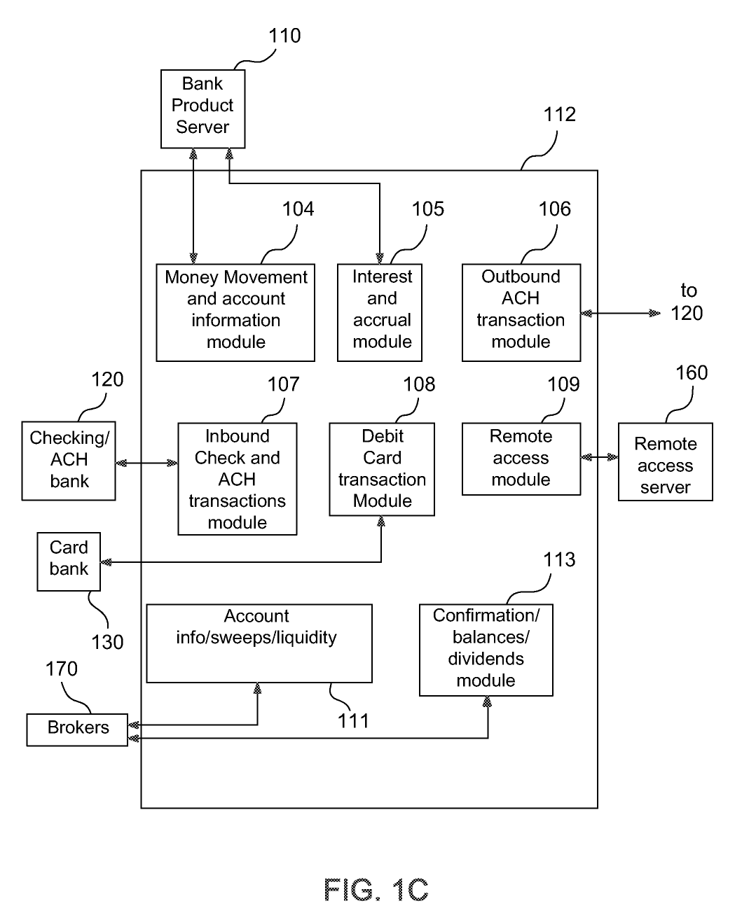

FIG. 1A is a view for explaining an environment in which example embodiments of the invention might be practiced. In particular, FIG. 1A depicts an example of a system in which funds are received and allocated across multiple accounts. Banking system 100 includes bank product server 110 and transfer agency system 112, which cooperate to perform functions such as keeping track of funds on a bank account level, computing interest, and performing allocation of customer funds, as described in more detail below. While in FIG. 1A banking system 100 is shown as a combination of two machines, it should be understood that bank product server 110 and transfer agency system 112 could be embodied as a single machine, or spread across any number of machines.

Generally, in the environment shown in FIG. 1A, there is a determination of an allocation of funds to multiple accounts. Information about financial transactions is received from multiple sources, and the information is aggregated to determine a total amount of allocatable funds. The allocatable funds include posted interest associated with the allocatable funds. Respective deposit rules are determined for each of the multiple accounts. A customer's accounts may include sub-accounts at the same bank. Deposit rules include a limit based on FDIC insurance. The allocation of the allocatable funds to the multiple accounts is determined based on a priority hierarchy set to the multiple accounts.

As used herein, “sub-accounts” refers to multiple different accounts at the same bank, of any type. In that regard, while it may be helpful from a systems or organizational perspective to refer to sub-accounts at the same bank, from the bank's perspective sub-accounts may simply be treated as multiple different accounts (without any “sub” connotation). For example, a bank may simply refer to one CD account and one MMDA account, as opposed to treating these as sub-accounts of the user at that bank. Accordingly, it should be understood that multiple accounts at the same bank fall within “sub-accounts” as used herein, regardless of what terminology is used by the bank or other entities.

In one embodiment, the priority hierarchy of the multiple accounts is set prior to the allocation according to parameters entered into the system, such as caps on deposits for a particular account or sub-account or predefined rules, e.g., term deposits (CD) accounts must be filled before MMDA accounts. In addition, the priority hierarchy can be adjusted to move particular accounts or sub-accounts higher or lower in the hierarchy, for example to satisfy term deposit limits. Funds are allocated such that each account or sub-account in the priority hierarchy is filled to its respective limit according to the respective deposit rules until the total amount of allocatable funds is allocated. The priority hierarchy can include a hierarchy for sub-accounts at the same bank.

From another perspective, a server (e.g., at a bank) can receive part or all of an allocation of funds to multiple accounts. The server receives the allocation of allocatable funds over a network, and the allocation of allocatable funds is determined according to the process described above.

As mentioned, the allocation must follow deposit rules, such as staying under an FDIC insurance limit, or not exceeding a certified maximum for a term deposit. Another deposit rule might correspond to certified max percentages of each account, in which percentages are defined to govern what percentage of an account in a bank can go into particular types of sub-accounts (e.g., term deposits vs. MMDA). For example, max percentages might be set by a customer or bank such that 25% of an overall account balance is the maximum can be in a term deposit, in order to, for example, limit exposure in any one particular account type. Moreover, priority may be set to accounts on a sub-account level, so that, for example, term deposits are filled before MMDA accounts, since the term deposits are fixed entities which have to be filled.

In FIG. 1A, on an ongoing basis, money movement and account information are transferred from transfer agency system 112 to bank product server 110. For example, throughout the day there may be transactions that are happening within the financial system such as debit card transactions, checking transactions, ACH transfers, and the like. Transfer agency system 112 collects and aggregates notifications of check transactions and ACH transactions (recurring or not) from checking/ACH bank 120 and notifications of debit card transactions from card bank 130 (also sometimes referred to as a “card issuer”). At some predetermined time, e.g., once or twice a day, all of the transactions and related information (balances, liquidity, etc.) are gathered together and posted on the system by transfer agency system 112, and sent to bank product server 110. Meanwhile, account information might include, for example, account type or taxpayer identification number (TIN) associated with a customer account. Bank product server 110 computes, for example, interest accrual information and allocation to multiple accounts in accordance with deposit rules.

Brokers/banks 140 send money in or out of the accounts. As shown in FIG. 1A, a remote access server 160 allows brokers/banks 140 to access the transfer agency system 112 that is on a network, via, for example, the World Wide Web (WWW) 150. Thus, for example, brokers/banks 140 can view money movement occurring in transfer agency system 112 in terms of debit card transactions, checking transactions, ACH transactions, or automated sweeps, etc. In one embodiment, different users at the broker/banks 140 have different access rights for access and/or manipulation of information within transfer agency system 112. For example, trusted brokers may be able to enter new transactions into transfer agency system 112, or modify information for previous transactions. In still another example, brokers/banks 140 may be able to transmit requests via remote access server 160 to opt certain accounts or sub-accounts out of the allocation program entirely.

Transfer agency system 112 may communicate with brokers 170 directly. In one embodiment, brokers 170 may transmit monetary information (e.g., account balance, liquidity, sweep transactions, etc.) and account information (e.g., name, address, TIN, etc.) to transfer agency system 112. Transfer agency system 112, in turn, may transmit associated statement files, settlement information and reconciliation information to brokers 170 including communications such as faxes or e-mails, or information needed by brokers 170 to reconcile their files or accounts with the allocations of funds being performed by bank product server 110. Thus, for example, transfer agency system 112 may transmit confirmations of transactions and balance files indicating balances or dividends to brokers 170.

As also shown in FIG. 1A, brokers 170 communicate directly with banks 180. In one example aspect, money movement is ordinarily not performed by transfer agency system 112 or bank product server 110, but by banks/brokers 140 or brokers 170. Put another way, transfer agency system 112 or bank product server 110 act as an allocation engine which accepts and aggregates information and returns allocations, but it is ordinarily the brokers and banks acting as entities which move the funds.

FIG. 1B is a block diagram collaboration diagram of functional modules deployed on bank product server 110 in accordance with an example embodiment. In particular, as shown in FIG. 1B, bank product server includes money movement and account information module 101, interest and accrual module 102, and statement/settlement/reconciliation information module 103.

Money movement and account information module 101 communicates with transfer agency system 112 to exchange money movement and account information between transfer agency system 112 and bank product server 110. For example, as mentioned above, throughout the day there may be transactions that are happening throughout the financial system such as debit card transactions, checking transactions, ACH transfers, and the like, which are transferred to bank product server 110. In addition, money movement and account information module 101 exchanges account information with transfer agency system 112. Such account information might include, for example, account type or taxpayer identification number (TIN) associated with a customer account.

Interest and accrual module 102 computes, for example, interest accrual information, as described above. To that end, interest and accrual module 102 communicates with transfer agency system 112 to transmit allocation information for indicating how posted interest is to be allocated to customer accounts and sub-accounts in the system.

Statement/settlement/reconciliation information module 103 exchanges transmit statement files, settlement information and reconciliation information with brokers 170 including information needed by brokers 170 to reconcile their files or accounts with the allocations of funds being performed by bank product server 110.

FIG. 1C is a block diagram collaboration diagram of functional modules deployed on transfer agency system 112 in accordance with an example embodiment.

In particular, transfer agency system 112 includes money movement and account information module 104, which exchanges money movement and account information with bank product server 110 as described above. Transfer agency system 112 also includes interest and accrual module 105, which receives interest accrual information from bank product server 110.

Outbound ACH transaction module 106 transmits outgoing ACH transactions (e.g., from other banks) to checking/ACH bank 120, whereas inbound check and ACH transactions module 107 receives check and ACH transactions from checking/ACH bank 120. Debit card transaction module 108 receives debit card transactions from card bank 130. Remote access module 109 communicates with remove access server 160 allow access to information from transfer agency system 112 to, e.g., brokers/banks 140.

Account info/sweeps/liquidity module 111 exchanges monetary information (e.g., account balance, liquidity, sweep transactions, etc.) and account information (e.g., name, address, TIN, etc.) with brokers 170. In addition, confirmation/balances/dividends module 113 transmits confirmations of transactions and balance files indicating balances or dividends to brokers 170.

Naturally, it should be understood that the above arrangements are simply examples, and other arrangements are possible according to example embodiments.

### III. Processes

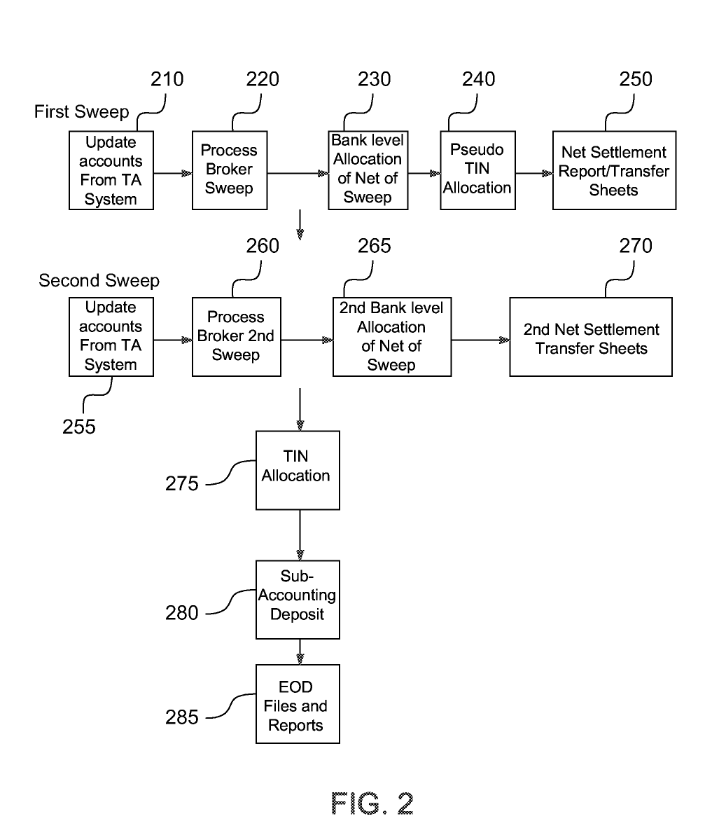

FIG. 2 is a flowchart diagram showing an exemplary procedure for sweeping allocatable funds into multiple accounts. In particular, FIG. 2 illustrates respective flow diagrams for a first and second sweep for allocation of funds to the multiple accounts.

The concept of first and second sweeps addresses situations in which, for example, additional transactions which occur late in the day or at other times in which such transactions are not immediately posted. For example, at the time of a first sweep, some money may be held back to cover withdrawals late in the day (ordinarily one bank is designated to handle this), or transactions may post later in the day after the first sweep. Thus, the second sweep may include these holdback amounts in addition to card transactions, checks or other late day transactions depending on a broker.

In some cases, there may not be a second sweep. In particular, while most clients (e.g., banks) might take part a second sweep as described above, some clients may choose to opt out or otherwise not participate in a second sweep. In such cases, the rest of the process (as described below) may proceed after a first sweep instead of after a second sweep.

A first “pseudo” allocation generates a preliminary allocation of funds, and a later second allocation determines the actual allocation. The first “pseudo” allocation may be run multiple times while taking into account parameter settings that need to be adjusted. In one example, bank product server 110 may verify that all of the accounts remain fully FDIC insured, i.e., that each account does not exceed the FDIC insurance threshold. In another example, a sub-account may have a CD, and the CD may require a certain level of money. In still another example, an outflow of assets might lead to a situation in which there is not enough money to fill a particular bank. If these deposit rules have not been met, parameters can be adjusted and the process can be run again. For example, the situation could be addressed by lowering deposit caps at other banks, or changing the priority in which the banks are filled (e.g., moving a particular bank higher in priority).

Referring to both FIGS. 1 and 2, in block 210, account information received from transfer agency system 112 is updated. As a result, bank product server 110 receives necessary money movement and account information from transfer agency system 112 for use in determining an allocation.

In block 220, a first broker sweep is processed. In particular, broker transactions (either from brokers/banks 140 or brokers 170) are swept from transfer agency system 112 to bank product server 110.

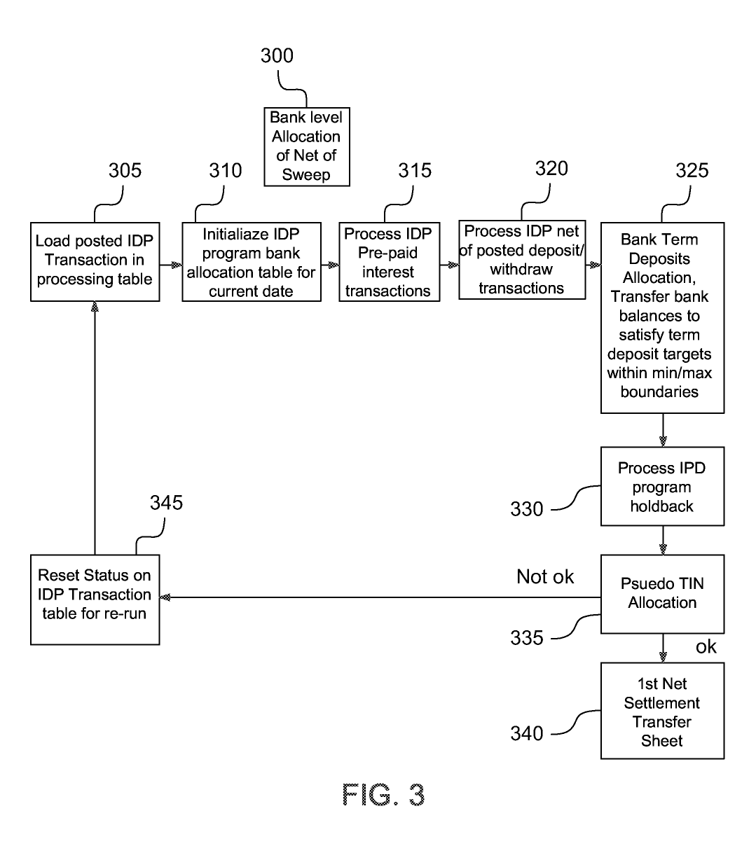

In block 230, a bank level allocation of the net of the sweep is performed. Generally, this involves netting transactions at an account level so as to determine a net amount for allocation. For example, at the account level there may be a transaction for a $100 purchase and a $50 redemption, in which case the net for allocation would be the net between the two (a $50 purchase). A more detailed description of how a bank level allocation of the net of the sweep is performed (block 230) is described below with respect to FIG. 3.

In block 240, a pseudo-TIN allocation is performed. As mentioned, TIN stands for Taxpayer Identification Number, which is one way of identifying a particular customer or client. Bank product server 110 determines the allocation of the net amount, taking into account the deposit rules at each bank. In particular, respective deposit rules are determined for each of the multiple accounts. The multiple accounts may include sub-accounts at the same bank, and the deposit rules may include a limit based on FDIC insurance and/or rules relating to paying interest on the respective account, or percentage limits for certain types of accounts (e.g., a limit for what percentage of a net account can be deposited as a term deposit).

The allocation of the allocatable funds to the multiple accounts may be based determined based on a priority hierarchy set to the multiple accounts. Funds can be allocated such that each account or sub-account in the priority hierarchy is filled to its respective limit according to the respective deposit rules until the total amount of allocatable funds is allocated. Specifically, the methodology of the allocation, both between banks and between sub-accounts at the same bank, may follow a waterfall approach in which banks and/or accounts are listed in a priority sequence, and in which the system tries to fill the banks in a waterfall fashion, i.e., fill the first bank, use the remainder of available funds to fill the second bank, use the remainder from that to fill the third bank, etc.

In addition to allocating funds to multiple accounts at multiple banks, TIN allocation according to this embodiment enables sub-allocation to different sub-accounts within the same bank, whether the sub-accounts are MMDA's, CD's, or otherwise. Thus, there are two or more layers of allocation being performed. In block 250, net settlement report(s) and/or transfer sheets are generated. For example, a transfer sheet or settlement report might be generated for a client's bank to indicate that a certain amount of money should be deposited or withdrawn from one or more accounts based on the allocation.

Referring still to FIG. 2, a second sweep is also performed. The second sweep is used for additional transactions which occur late in the day or at other times in which such transactions are not immediately posted, as discussed above. The pseudo TIN allocation in the first sweep and the TIN allocation in the second sweep essentially perform the same process, except that the pseudo TIN allocation does not update the database of customer accounts, whereas the TIN allocation does (via the brokers/banks). More specifically, a pseudo TIN allocation can be run first, to make sure that any problems or misallocations (i.e., exceeding an FDIC deposit limit) are corrected before the allocations are processed and output. According to the embodiment, bank product server 110 may take an early file and allocate across the banks based upon the early file, and subsequently input a late file to allocate the customer's money. In other examples, a file may be sent early and then supplemented with additional transactions later in the day.

In one example aspect, a preliminary balance is used to account for transactions which have not been posted. Such transactions do not technically exist in the system yet, so they are tracked in the preliminary balance. In one example, a file can be sent from banks/brokers that indicate preliminary activities of the account, and then final numbers are sent at some point later in the day.

Turning to the second sweep, in block 255, account information received from transfer agency system 112 is updated. Transfer agency system 112, in turn, updates bank product server 110 with information about, e.g., late day transactions.

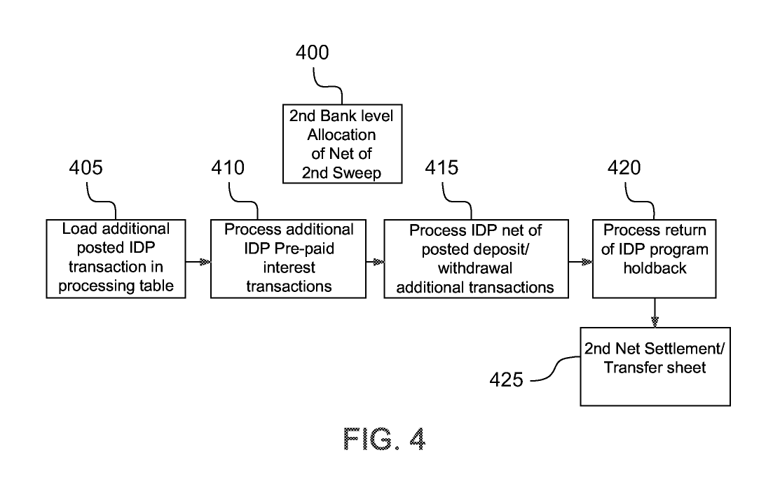

In block 260, a broker second sweep is processed. Block 265 corresponds to the bank level allocation of the net of the net of the second sweep, which is described in further detail with respect to FIG. 4.

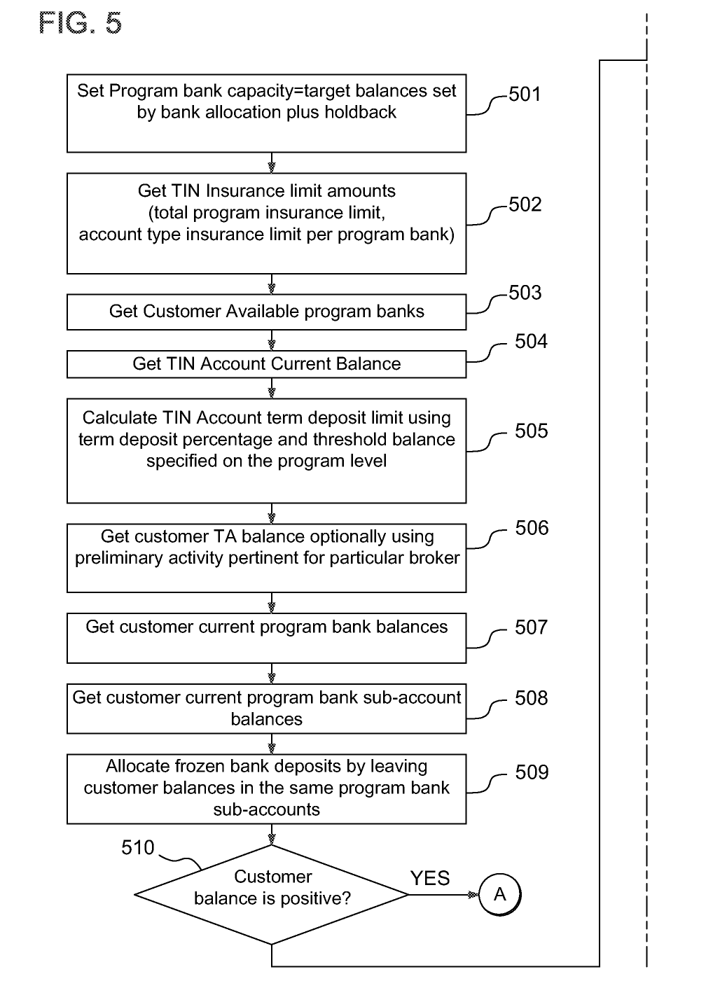

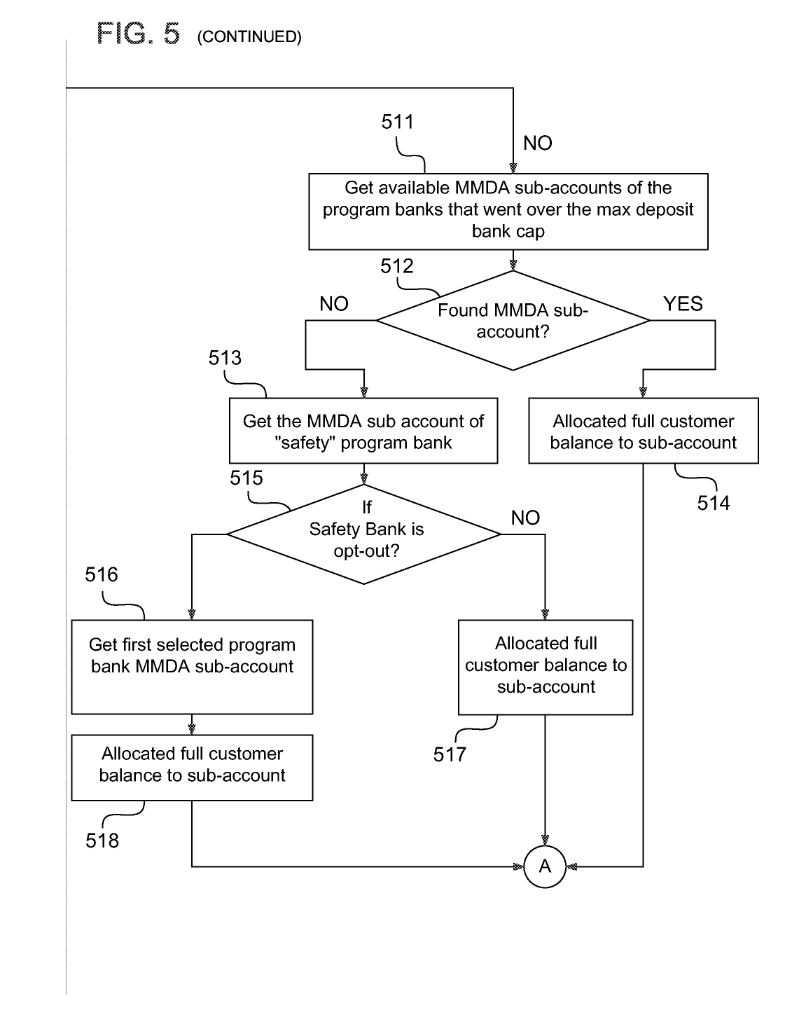

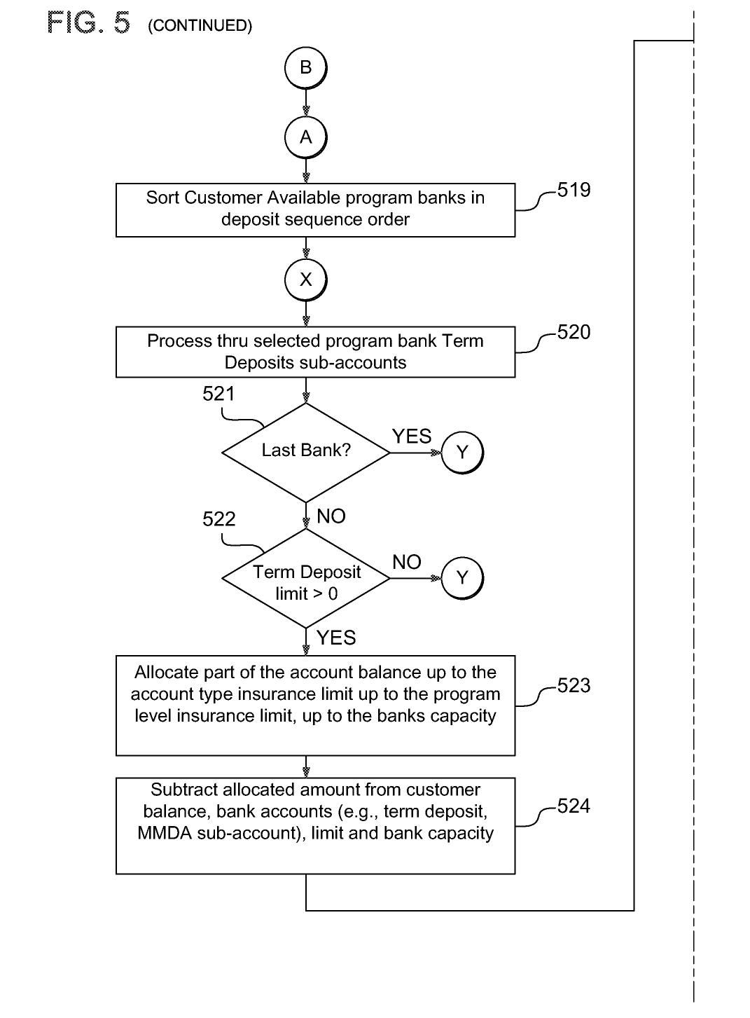

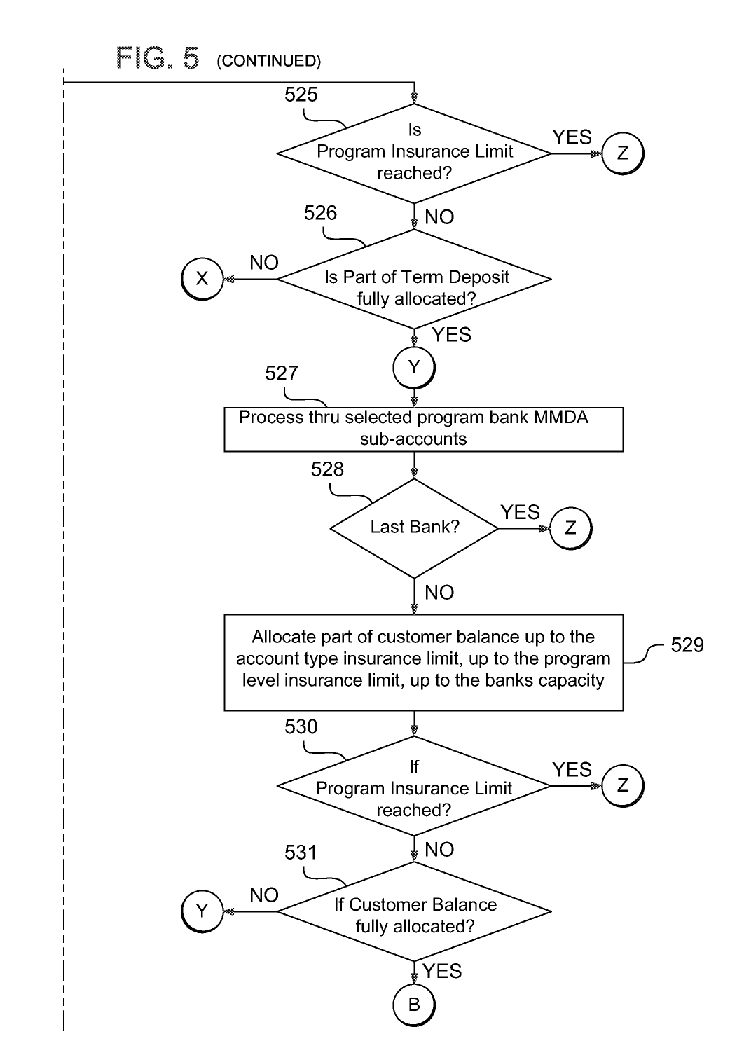

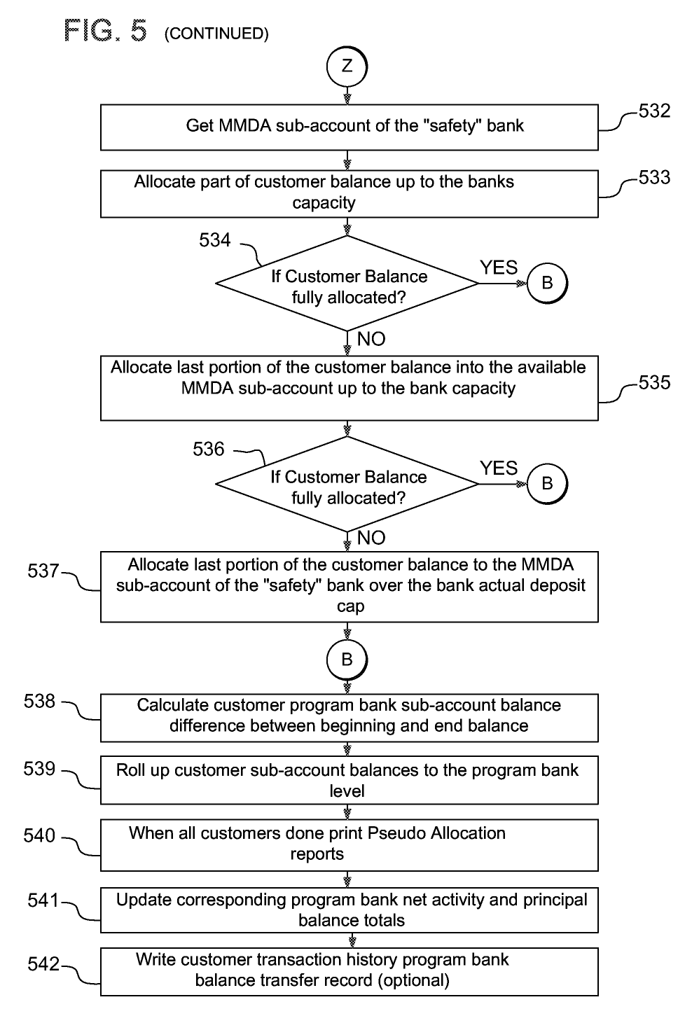

Following block 260, block 275 performs TIN allocation (in contrast to the earlier pseudo-allocation). TIN allocation is described more fully with respect to FIG. 5.

Block 280 includes performing a sub-accounting Divpost which will be described more fully below, but generally corresponds to a process in which interest which may not pay until a set date (e.g., in the case of a term deposit) can nonetheless be allocated to an account or sub-account prior to that set date.

Block 285 includes generating end of day (EOD) files and reports which can be used by banks and brokers for updating and/or reconciling the client's account(s).

Returning back to the main process of the sweep, in block 265, a second bank level allocation of the net of the sweep is performed, based on the outcome of blocks 275, 280 and 285.

In block 270, net settlement report(s) and/or transfer sheets are generated to represent the output of the second allocation.

FIG. 3 is a flowchart diagram showing another exemplary procedure for allocation of funds amongst financial institutions.

In particular, FIG. 3 illustrates a bank level allocation 300 which takes the transactions that have been posted from transfer agency system 112/bank product server 110, and inserts them into a database on the bank(s) side. This process corresponds generally to step 230 in FIG. 2, and describes a pseudo-TIN allocation at the bank level.

In block 305, the posted insured deposit program (IDP) transactions are loaded in a processing table. Thus, for example, a set of transactions for a particular customer is loaded for processing.

In block 310, the IDP program bank allocation table is initialized for the current date. In particular, a table used to store allocations may be cleared of previous values.

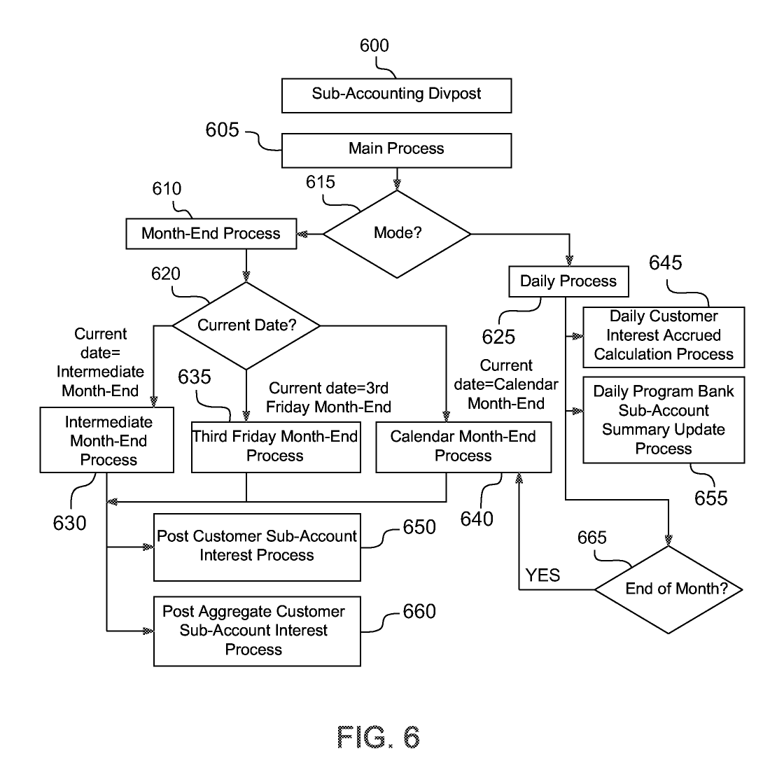

In block 315, IDP pre-paid interest transactions are processed. For example, interest which might not yet pay due to rules on the fund (e.g., term deposits) may be paid by the broker before the term of the account is up, with the broker being reimbursed from the customer's account when the interest is paid out. This process is described more fully below with respect to FIG. 6.

In block 320, the IDP net of posted deposit/withdrawal transactions are processed. Thus, for example, the net amount available for allocation is determined from the net of all deposits and withdrawals up to that time.

In block 325, bank term deposits are allocated, and bank balances are transferred to satisfy term deposit targets within minimum/maximum boundaries. In this example, term deposits (such as CD's) are higher priority, and thus funds are allocated to them first. In particular, taking the net of the deposits and withdrawals, bank product server 110 determines how to allocate funds. In the case of term deposits, bank product server 110 may further verify that the amount of money deposited is equal to the amount of the certificate. For example, with certain items such as CD's being a fixed asset, bank product server 110 verifies that the bank is receiving funds up to the certificate amount.

In block 330, IDP program holdbacks are processed. In particular, as mentioned above, a bank may hold back a particular amount of money to cover withdrawals which might happen later in the day. Thus, the system tracks these holdbacks and takes them into account in generating the pseudo allocation.

In block 335, the pseudo-TIN allocation is performed for all accounts including term deposit and MMDA accounts. In turn, a determination is made as to whether the outcome of the allocation is “ok”. In particular, bank product server 110 may verify that all deposit rules for each of the banks and accounts/sub-accounts are satisfied. For example, bank product server 110 may verify that all of the accounts remain fully FDIC insured, i.e., that each account does not exceed the FDIC insurance threshold. In another example, a sub-account may have a CD, and the CD may require a certain level of money. In still another example, an outflow of assets might lead to a situation in which there is not enough money to fill a particular bank. If these deposit rules have not been met, parameters can be adjusted and the process can be run again. For example, the situation could be addressed by lowering deposit caps at other banks, or changing the priority in which the banks are filled (e.g., moving a particular bank higher in priority).

In block 335, if the outcome of the process is ok, the process proceeds to block 340 to perform the first net settlement and generate transfer sheets. On the other hand, if the outcome of the pseudo-TIN allocation is not ok, the process proceeds to block 345 to reset the status on the IDP transaction table for a re-run of the pseudo-TIN allocation, and proceeds to block 305 to repeat the process.

FIG. 4 is a flowchart diagram showing another exemplary procedure for allocation of funds amongst financial institutions. In particular, FIG. 4 is a view for explaining a bank level allocation of the net of the second sweep. The bank level allocation calculates the net of the sweep and then creates a deposit (usual) or withdrawal (rare—only occurs if the net of the sweep is a withdrawal that exceeds the holdback) to the holdback bank.

If there were no late withdrawals and those holdbacks were ultimately not needed, the full holdback amount gets returned to the bank.

In block 405, the additional posted IDP transactions are loaded in the processing table. In block 410, the additional IDP pre-paid interest transactions are processed.

In block 415, the IDP net of posted additional deposit/withdrawal transactions are processed.

In block 420, returns of IDP program holdbacks are processed, as discussed above.

In block 425, the second net settlement/transfer sheets are sent to clients and/or brokers and banks, as necessary.

FIG. 5 is a flowchart diagram showing an exemplary procedure for determining an allocation of funds to multiple accounts.

As shown in FIG. 5, the allocation of funds is not only to the banks, but also to sub-accounts at the same bank. Meanwhile, the allocation follows deposit rules, such as staying under an FDIC insurance limit, or not exceeding a certified maximum for a term deposit. Another deposit rule might correspond to certified max percentages of each account, in which percentages are defined to govern what percentage of an account in a bank can go into particular types of sub-accounts (e.g., term deposits vs. MMDA). For example, max percentages might be set by a customer or bank such that 25% of an overall account balance is the maximum can be in a term deposit, in order to, for example, limit exposure in any one particular account type. Moreover, priority may be set to accounts on a sub-account level, so that, for example, term deposits are filled before MMDA accounts, since the term deposits are fixed entities which have to be filled.

Turning to FIG. 5, in block 501, a program bank capacity is set to the sum of target deposit balances set for the bank allocations and holdback. Put another way, the allocation is handled for a particular bank/account by counting down from an overall target deposit balance, i.e., starting with the amount of money that should be deposited into the target balance and then subtracting from that number as money is deposited, until it reaches zero.

In block 502, bank product server 110 accesses insurance limit amounts. In this regard, insurance limits (including those other than FDIC) may be based on account types. For example, an individual account may be insured only up to $250,000, whereas a joint account might be insured up to $500,000.

In block 503, bank product server 110 calls up available program banks In particular, a client, broker or bank may opt out certain banks from the allocation process. For example, a customer may have ten banks but only wish to allow two of them to be participants in the allocation process. The opt out may be set by the customer, broker or bank prior to the allocation process.

In block 504, bank product server 110 gets the TIN (Taxpayer ID Number for the user) account overall net or aggregate current balance across all accounts and sub-accounts. Thus, a customer's account balances and sub-account balances at different banks can be combined for allocation purposes.

In block 505, bank product server 110 calculates term deposit limits using term deposit percentages and threshold balances specified on the program level. Thus, for example, bank product server 110 calculates the amount of money that can be deposited into each bank certificate of deposit based on the percentage limitation on the account.

In block 506, bank product server 110 obtains a customer transfer agency balance, optionally using preliminary activity pertinent for a particular broker. In particular, as discussed above, there may be two or more sweeps from brokers or other financial entities in order to, for example, account for holdbacks and late transactions.

In blocks 507 and 508, bank product server 110 obtains the current customer balances of the accounts across the banks and sub-accounts within those banks.

In block 509, frozen bank deposits are accounted for by avoiding customer balances in such sub-accounts for purposes of the allocation. Specifically, this block deals with the concept of freezing a bank's money in case there is a bank failure. Thus, if a bank is on a frozen bank list, money can not be withdrawn. According to the example embodiment, however, this process may also apply on a sub-account level, i.e., particular sub-accounts may be frozen, and as such customer balances in those sub-accounts are left alone during the allocation.

In block 510, there is a determination of whether the customer net balance is positive. If so, the process simply proceeds to step 519 to begin allocation. On the other hand, if the balance is not positive, bank product server 110 attempts to remedy the situation by obtaining funds from other banks, or attempts to post the negative balance to a safety bank. In that regard, a safety bank is a bank account or sub-account generally designated for storing excess allocatable funds which can not be allocated to any other of the multiple accounts, but in this context, the safety bank can also be used to absorb a negative balance.

If the safety bank has been opted out of the system, then bank product server 110 attempts to post the negative balance to other available banks. More specifically, in block 511, bank product server 511 obtains available MMDA sub-accounts of the program banks that went over a maximum deposit cap. If it is determined in block 512 that such an account is found, the (negative) customer balance is applied to that sub-account to offset the excess, and the process proceeds to block 519. If an MMDA sub-account over the deposit cap is not found in block 512, the process proceeds to block 513 to obtain an MMDA sub-account of the safety bank. In block 515, there is a determination of whether the safety bank has been opted out of the process. If not, the process proceeds to block 517 to allocate the full (negative) customer balance to the safety bank MMDA sub-account, and the process proceeds to block 519. If the safety bank has been opted out, the process proceeds to blocks 516 and 518 to attempt to post the negative balance to another account, namely the first MMDA program bank sub-account, and the process proceeds to block 519.

In block 519, customer available program banks are sorted in deposit sequence order. In particular, as discussed above, a priority order may be set to the different banks/accounts so that they are filled in a particular order. Thus, it is possible to control how much money goes not only into a bank, but also into a particular sub-account or sub-accounts.

In block 520, bank product server 110 processes through the selected bank term deposits sub-accounts.

In this example, funds are allocated first to term deposits as first priority, although other priority orders could be set. If the currently term deposit processed sub-account is the last bank, then the allocation is essentially finished as far as term deposits, and the process proceeds to block 527. On the other hand, if the currently processed bank is not the last bank, there is a determination in block 522 of whether the term deposit limit is greater than zero. For example, the term deposit limit might be that the most a person can have in a particular term is $200,000. In such a case, money can be allocated to that term deposit account to $200,000, but once that limit is reached the rest of the money has to go elsewhere (e.g., non-term deposit sub-accounts).

Other limits or parameters might also be included, thus allowing for control of money not only to a particular bank, but also to a particular sub-account within that bank based on, e.g., the type of sub-account.

If the limit has been exceeded, the process proceeds to block 527. On the other hand, if the term deposit limit has not been exceeded, the process proceeds to block 523 to allocate part of the account balance up to the account type insurance limit, the program level insurance limit, and the bank's capacity (e.g., bank account term deposit limit based on percentage). Accordingly, money is allocated to that account to the extent possible before moving to another bank or account.

In block 524, the allocated amount is subtracted from the relevant customer balance bank accounts and bank capacity.

In block 525, there is a determination of whether the program insurance limit (e.g., FDIC) has been reached. If so, the process proceeds to block 532 to allocate money from the term deposit account/sub-account to a safety account and thereby drop the term deposit account/sub-account back under the insurance limit. If not, there is a determination in block 526 of whether the term deposit part of the customer's accounts have been fully allocated. If not, the process proceeds back to block 520 to loop through the next term deposit account. If the term deposit part of the customer's account has been fully allocated, then the process moves to block 527 to process through MMDA accounts, which in this example are lower priority.

In block 527, bank product server 110 processes through the selected MMDA sub-accounts. If the currently processed bank is determined at block 528 to be the last bank, the process proceeds to block 532. Otherwise, the process proceeds to block 529, in which part of the customer balance is allocated to the current MMDA account up to the account type insurance limit, the program level insurance limit, and the bank's capacity (e.g., bank account term deposit limit based on percentage). Put another way, money is allocated to that account to the extent possible before moving to another bank or account.

In block 530, there is a determination of whether the program insurance limit for the current MMDA account/sub-account has been reached. If so, the process proceeds to block 532 to allocate money from the MMDA account/sub-account to a safety account and thereby drop the MMDA account/sub-account back under the insurance limit. If not, there is a determination in block 531 of whether the customer balance has been fully allocated. If the customer balance has been fully allocated, the process proceeds to block 538 to finish the allocation process. Otherwise, the process proceeds to block 527 to process the next MMDA account.

In block 532, the bank product server obtains the MMDA sub-account of the safety bank. The safety bank is designated for storing excess allocatable funds which can not be allocated to any other of the multiple accounts. Thus, for example, excess allocatable funds are stored in the safety bank in a case that deposits in the other multiple accounts have all reached an FDIC insurance limit.

In block 533, the customer balance (or part thereof) is allocated up to the capacity of the safety bank. Thus, to the extent possible, the excess funds are dropped into the safety bank. Nevertheless, the safety bank may also have limits.

Thus, in block 534, there is a determination of whether the customer balance is fully allocated. If the customer balance is fully allocated, the process proceeds to block 538. If not, the process proceeds to block 535, where the last portion of the customer balance is allocated into any available MMDA sub-accounts up to the banks capacity. Then, in block 536, there is another determination of whether the customer balance is fully allocated. If the customer balance is fully allocated, the process proceeds to block 538. If not, the process proceeds to block 537, where the last portion of the customer balance is allocated to the MMDA sub-account of the safety bank, even over the bank deposit cap.

In block 538, bank product server 110 calculates the difference between customer program sub-account balance at the beginning of allocation and the customer program sub-account balance at the end of allocation. In block 539, the customer sub-account balances are rolled up to the program bank level (e.g., to an “overall” account level) to be used in generating reports. In block 540, when allocation has been done for all customers, bank product server 110 generates and prints allocation reports summarizing the outcome of the allocation. Program bank net activity and principal balance totals are updated in block 541, and a customer transaction history program bank balance transfer record is written in block 542.

FIG. 6 is a flowchart diagram showing an exemplary procedure for an interest posting process.

In the examples that follow and in general, it should be understood that while the disclosure may refer to a “customer's CD” or the customer “purchasing” the CD for purposes of conciseness, assets such as CDs may in fact be acquired by a broker acting as an agent for the exclusive benefit of multiple deposit customers. Put another way, an individual customer may not purchase a CD or other account on his/her own, and instead the broker acts as agent for the exclusive benefit of multiple deposit customers on the same single CD or account. In such cases, “allocation” may refer to allocating a customer's share of an asset or interest thereon as opposed to the entire asset or interest.

Generally, in terms of posting interest to customer accounts and keeping account of interest paid to the customer (by a broker or otherwise), a situation can arise where the actual pay date of interest may not coincide with when such interest is needed or desired. For example, while a MMDA account can ordinarily pay interest on the same day it's requested, for a term deposit such as a CD, the bank or CD holder may wish to wait until maturity of the CD to pay the interest. On the other hand, a customer may wish to liquidate the CD and get the interest early, before the maturity of the CD. Also, in some situations a broker may normally pay interest at the end of each month, but because the CD pays only at maturity, this interest must be pre-paid. Or, a CD may mature in the middle of a month causing the system to post-pay the interest due at the end of the month when the broker normally makes these payments.

In a specific example, assume a CD doesn't mature until 6 months, but a customer liquidates and therefore needs interest to be paid on a particular pay date (e.g., the 15^{th} of the month). According to example embodiments, the broker pays this interest to the client, and the system notes that the customer has been paid the interest, but also the deficiency of what needs to be paid to the broker. The system tracks interest which is pre-paid by the broker to the customer, and then pays back the broker upon maturity of the CD. This situation can be called “prepaid reinvestment”. In some situations, a broker may prepay interest for all clients, not just clients who are liquidating. Moreover, in some situations posted interest on the certificate of deposit is pre-paid and allocated in the course of multiple payments over multiple periods (e.g., once a month over multiple months) before the payment date of the certificate of deposit.

Another situation can arise when a customer has already received interest on a CD, but the broker holding the CD does not pay the interest until a later date. In a specific example, assume that a customer has bought a CD that pays on the 15^{th} of the month, but with a broker who pays the customer on the 30^{th}. In this case, the broker will pay the interest on the 30^{th} for the first 15 days interest after already receiving the interest. The system tracks this, and on the 15^{th} of the following month, when the CD does pay out, the broker is paid back for that first 15 days. Meanwhile, the interest for the next 15 days will be tracked and held until the broker pays the customer on the next pay date (30^{th}).

In another example, a broker acting as agent for the exclusive benefit of deposit customers may purchase a $200M CD on the 5^{th} of the month, but for that particular broker it's paid to the customers on the 15^{th} of the month. On the 5^{th} of the month, the interest may be paid out to the broker, but at that time will not yet have been paid to the client. This type of interest in these examples to as “post-paid interest”, as the customer is receiving the interest after the interest is paid to the broker.

FIG. 6 depicts an example of a “Sub-Accounting Divpost” process 600, in which accrued interest on a sub-account can be posted prior to the end of the accrual term.

In that regard, on a daily basis a customer interest accrual calculation process determines how much interest each account is accruing. In one aspect, a daily program bank sub account process determines what amount of interest is accrued in each of the sub-accounts. Within month-end processing, there can be different month ends, such as intermediate month end, third Friday, or calendar month end. In addition, the month end can be set to a variable date within the month. If it is a month-end day, then whatever interest has been accrued to this account is posted to the sub-account. For example, a complete balance might accrue $10 in interest across the account. Of that, $5 may be in bank A and $5 may be in Bank B. Further, Bank B might have a certificate of deposit which accrued $3 dollars in interest and an MMDA account which accrued $2 of interest. All the interest gets posted into the balances, and Bank B is notified of the interest that they have to post that they get on a total basis.

Meanwhile, the Divpost process can be run either to process a daily process where interest is accrued, or at month's end in which case interest is not only accrued but it is also posted, specifically, accrued for the next month and posted for the previous month.

The Sub-Account Divpost process also takes into account “breakage” between the sub-accounts. Breakage is a loss in some percentage of interest rate due to rounding rules at multiple institutions. In a simplified example, a main account which tracks a total of all of a customer's money might end up with 10 cents of accrued interest at the end of the month. Nevertheless, if that same money were spread across multiple banks, and those banks rounded off parts of a percentage points of interest, a situation could arise in which only 8 cents of accrual are added to the account across the multiple banks Thus, in some sub-accounts, rounding down rules for the interest rate might cut off percentage points of interest, and this loss needs to be made up in order to achieve the same interest rate that would be achieved for the total sum of money were it not split among the accounts or sub-accounts.

Thus, the process verifies that the posted interest determined to be allocated across the multiple accounts corresponds to an amount of interest that would be posted on the total amount of allocatable funds. Accordingly, bank product server 110 tracks interest not only at the bank level, but at the account and sub-account level.

Turning to FIG. 6, the main process begins in block 605, and in block 615 there is a determination of whether the system is in a month-end process mode or a daily process. If the system is in a daily process mode, the process proceeds to block 625, which causes a daily customer interest accrual calculation in block 645, and a daily program bank sub-account summary update process in block 655, as described above.

In block 665, it is determined whether the end of the month has been reached. If so, the process proceeds to block 640.

Meanwhile, if it is determined in block 615 that the system is in a month-end process mode, the process proceeds to block 620 to determine the current date. If the current date matches the intermediate month/end date (block 630), the third Friday month-end date (block 635) or the calendar month end date (block 640), the process initiates a post customer sub-account interest process 650 for each sub-account and a post aggregate customer sub-account interest process 660 for all of the customer's accounts to post interest to the sub-account or accounts, including post-paid or pre-paid interest.

A number of examples of a interest funding scenarios for term deposits will now be described. In each of the following examples, it is assumed that a broker ABC has one customer account and three program banks Bank 001 has one term deposit bank sub-account in which interest is tracked term-to-date (TTD). Bank 002 is a safety bank including one MMDA account. Bank 003 also has one MMDA sub-account.

### Example 1

Example 1 is for explaining an allocation process flow according to an example embodiment.

According to this example, one goal of the allocation process flow is to have the sum of the customer's sub-account balances match the sum of customer account principal balances at the end of each day.

In this example, the overall customer account (e.g., aggregate of all sub-accounts) has a principal balance of $750,000, with month-to-date (MTD) accrued interest of $0. Bank 001 term deposit sub-account has a principal balance of $0 with month-to-date (MTD) accrued interest of $0. Bank 002 (the safety bank) MMDA sub-account has a principal balance of $500,000 with month-to-date (MTD) accrued interest of $0. Bank 003 MMDA sub-account has a principal balance of $250,000 with month-to-date (MTD) accrued interest of $0.

Assume that in this example, in Month 1, Day 15, a two-month term deposit sub-account is opened at bank 001 for $250,000. The Bank 001 term deposit sub-account can be funded via an allocation transfer from bank 002. Put another way, the money for the opened term deposit sub-account already exists in the program, but now the CD (term deposit) can be purchased using the funds from the Bank 002 (safety bank) MMDA sub-account. Thus, the allocation process withdraws $250,000 from Bank 002 (safety bank) MMDA sub-account and deposits it to Bank 001, thereby funding the term deposit sub-account.

### Example 2

Example 2 is for explaining an interest post process flow, at the overall or aggregate customer account level. In this context, “post” refers to the interest posting to the customer account.

In Example 2, the total customer account continues to have a principal balance of $750,000, but now has accrued MTD interest of $154.11. At the end of month 1, the $154.11 accrued interest is added to the customer account balance. Thus, at the end of month 1, the customer account has a principal balance of $750,154.11, with interest accrued MTD now back to $0.

### Example 3

Example 3 is for explaining an interest post process flow, at the bank sub-account level. Thus, Example 3 corresponds to Example 2, but at the sub-account level. In this example, it is assumed that it is still the end of month 1.

In Example 3, it is further assumed that Bank 001 term deposit sub-account has accrued customer interest of $51.37 month-to-date (MTD) and, correspondingly $51.37 total to date (TTD). Meanwhile, the MMDA accounts at Bank 002 and Bank 003 each have also accrued interest of $51.37 (thus equalling the total $154.11 overall interest in Example 2). Notably, the Bank 001 term deposit sub-account will not pay interest until the end of the two month term.

An interest post process will add earned customer interest to the respective MMDA bank sub-account balances. On the other hand, the Bank 001 term deposit sub-account does not pay interest at the end of month 1 (being a two-month term). Therefore, the interest post process will add the term deposit customer interest to the safety bank balance at Bank 002 (safety bank) MMDA sub-account.

Thus, in this example, prior to the posting process, Bank 001 term deposit sub-account, Bank 002 (safety bank) MMDA sub-account and Bank 003 MMDA sub-account each have a principal balance of $250,000 and accrued interest (MTD) of $51.37.

During the posting process, the $51.37 accrued interest from each sub-account is posted. For the MMDA accounts at Bank 002 and Bank 003, this is as simple as moving the $51.37 from accrued interest to the principal balance of the sub-account. However, as noted above, the Bank 001 term deposit sub-account will not pay interest until the end of the two month term. Accordingly, the $51.37 interest from the term deposit sub-account at Bank 001 is not added to the balance of Bank 001, but rather is added to the principal balance of the MMDA account at the Bank 002 (safety bank) MMDA sub-account. This pre-paid interest is tracked at the Bank 001 sub-account level as being both earned and pre-paid. The Bank 002 (safety bank) MMDA sub-account also tracks the $51.37 interest as posted prepaid term interest, as the prepaid interest was posted there.

Thus, at the end of the posting process, Bank 001 term deposit sub-account has a principal balance of $250,000, Bank 002 (safety bank) MMDA sub-account has a principal balance of $250,102.74 (including the $51.37 interest from itself and the $51.37 prepaid interest from Bank 001), and Bank 003 MMDA sub-account has a principal balance of $250,051.37.

### Example 4

Continuing from the previous example, and still assuming that the timing corresponds to the end of Month 1, an allocation process example will now be described, at the program bank sub-account level. In particular, Example 4 describes reallocating in order to account for FDIC insurance limits. In this example, it can be assumed that the FDIC insurance limit for Bank 003 MMDA sub-account is $250,000. At the end of Example 3 (the interest posting process), Bank 003 MMDA sub-account principal balance is $250,051.37, which is over the FDIC insurance limit.

Thus, in Example 4, with respect to maintaining a fixed sub-account balance and account insurance limit at Bank 003, an allocation process reshuffles bank account balances by withdrawing $51.37 from Bank 003 MMDA sub-account and depositing the $51.37 in the Bank 002 (safety bank) MMDA sub-account.

Accordingly, after allocation processing, Bank 001 term deposit sub-account has a principal balance of $250,000, Bank 002 (safety bank) MMDA sub-account has a principal balance of $250,154.11 (the interest from all three banks), and Bank 003 MMDA sub-account has a principal balance of $250,000.

### Example 5

Example 5 is another example of an interest post process, from the perspective of a total customer account (an aggregate of all the sub-accounts). In Example 5, it is assumed that it is now the end of Month 2. Further, it is assumed that the total net customer account has month to date (MTD) interest of $308.22 that posts to the principal balance of the customer account.

Thus, before the posting of the interest, the Customer Account has a principal balance of $750,154.11 and interest accrued MTD of $308.22. The posting process simply adds the accrued interest to the balance, and thus at the end of the interest posting process the customer account has a principal balance of $750,462.33 and interest accrued MTD of $0.

### Example 6

Example 6 describes the example of the interest posting process flow of Example 5, but at the level of the program bank sub-accounts. Thus, in this example, it is still assumed that it is the end of Month 2.

Keeping in mind from Example 1 that the two-month term deposit sub-account was opened at bank 001 at Month 1, Day 15, at the end of Month 2 the Bank 001 term deposit sub-account is still not at the end of its term. Thus, to the extent that interest is being paid at the end of Month 2, the broker must prepay the interest before the end of the term. Put another way, the broker is prepaying month end customer reinvested interest, because the boundary of the term deposit is not on the monthly boundary that the system works on for everything else.

In this example, Bank 001 term deposit sub-account has now accrued customer interest of $102.74 MTD, and $154.11 TTD ($102.74 plus the earlier $51.37). The MMDA sub-accounts at Bank 002 & 003 each have accrued interest of $102.74. The interest post process will simply add earned customer interest to the MMDA sub-account balances at Bank 002 and Bank 003. On the other hand, for the Bank 001 term deposit sub-account, which does not pay at the end of Month 2, the interest posting process will again add the interest to the Bank 002 (safety bank) MMDA sub-account.

Accordingly, before the interest posting, Bank 001 term deposit sub-account has a principal balance of $250,000 and accrued interest (MTD) of $102.74, Bank 002 (safety bank) MMDA sub-account has a principal balance of $250,154.11 and accrued interest (MTD) of $102.74, and Bank 003 MMDA sub-account has a principal balance of $250,000 and accrued interest (MTD) of $102.74.

During the posting process, the $102.74 accrued interest from each sub-account is posted. For the MMDA accounts at Bank 002 and Bank 003, this is as simple as moving the $102.74 from accrued interest to the principal balance of the sub-account. However, as noted above, since the Bank 001 term deposit sub-account was opened on Day 15 of month 1, it still has not reached the end of the two month term. Accordingly, the $102.74 interest from the term deposit sub-account at Bank 001 is not added to the balance of Bank 001, but rather is added to the principal balance of the Bank 002 (safety bank) MMDA sub-account. This pre-paid interest is tracked at the Bank 001 term deposit sub-account level as being both earned and pre-paid. Moreover, the TTD pre-paid at Bank 001 sub-account is now $154.11 (the $102.74 from month 2 and the $51.37 from month 1). The Bank 002 (safety bank) MMDA sub-account also tracks the $102.74 interest as posted prepaid term interest, as the prepaid interest was posted there.

Thus, at the end of the posting process, Bank 001 term deposit sub-account has a principal balance of $250,000, Bank 002 (safety bank) MMDA sub-account has a principal balance of $250,359.59 (the previous $250,154.11 balance plus the $102.74 from Bank 001 and the $102.74 from Bank 002), and Bank 003 MMDA sub-account has a principal balance of $250,102.74.

### Example 7

Example 7 is an example for an allocation process flow at the sub-account level, at the end of Month 2. As in the previous allocation, Example 7 describes reallocating in order to account for FDIC insurance limits. In this example, it can be assumed that the FDIC insurance limit for Bank 003 MMDA sub-account is $250,000. At the end of Example 3 (the interest posting process), Bank 003 MMDA sub-account principal balance is $250,102.74, which is again over the FDIC insurance limit.

Thus, in Example 7, with respect to maintaining a fixed sub-account balance and account insurance limit at Bank 003, an allocation process reshuffles bank account balances by withdrawing $102.74 from Bank 003 MMDA sub-account and depositing the $102.74 in the Bank 002 (safety bank) MMDA sub-account.

Accordingly, after allocation processing, Bank 001 term deposit sub-account has a principal balance of $250,000, Bank 002 (safety bank) MMDA sub-account has a principal balance of $250,462.33, and Bank 003 MMDA sub-account has a principal balance of $250,000.

### Example 8

Example 8 is an example for describing another example of an interest post process, from the perspective of the total customer account (an aggregate of all the sub-accounts). In Example 8, it is assumed that it is now Month 3, Day 15. As such, the term of the underlying term deposit sub-account component at Bank 001 will post interest.

In this example, the total customer account has month to date (MTD) interest of $154.11, essentially for the 15 days in Month 3. Nevertheless, the $154.11 will not post until the end of Month 3, even though the underlying term deposit sub-account component at Bank 001 will post interest because it's come to term.

### Example 9

Example 9 follows up on the Example of FIG. 8, and describes a term deposit interest post process at the sub-account level. Again, it is assumed that it is Month 3, Day 15.

In Example 9, the Bank 001 term deposit sub-account has accrued customer interest of $51.37 MTD and $154.11 TTD. Additionally, in this example, the Bank 001 term deposit sub-account must post interest and liquidate on the business date representing the end of the term.

Accordingly, a daily term deposit expiration interest post process will post term deposit interest for any term deposit bank sub-accounts that have reached their maturity. If there are any, the term deposit sub-account bank balances will be updated by the TTD Customer Interest, TTD Prepaid Interest Refund and customer interest held past term, as discussed below. Any term deposit bank sub-accounts maturing on date other than the period end will transfer all paid interest out of the program. In order to properly handle customer account liquidations for accounts with MTD interest accrued in term deposit bank sub-accounts past term expiration, the interest can remain in place for prepaid offsetting until the end-of-month. In one example, the daily term deposit expiration interest post process is designed to run on calendar month end, prior to the existing interest posting.

Thus, before the daily term deposit expiration interest post process, the Bank 001 term deposit sub-account has a principal balance of $250,000, accrued interest of $51.37 (MTD, for month 3 so far), $205.48 accrued interest TTD (total interest since opening the account: $102.74 from month 2 plus the $51.37 from the half of month 1 and the $51.37 from the half of month 3), and prepaid reinvestment interest of $154.11 (the total prepaid interest previously posted to safety Bank 002: $51.37 plus $102.74).

The daily term deposit expiration interest post process takes the $205.48 TTD accrued interest in the Bank 001 term deposit sub-account, subtracts a $154.11 prepaid interest refund, and subtracts $51.37 for interest held past term (the current Month 3 interest, which will be held past the term of the term deposit).

After the daily term deposit expiration interest post process, the Bank 001 term deposit sub-account still has a principal balance of $250,000 and interest accrued MTD of $51.37, which is also tracked as held past term.

### Example 10

Example 10 is another example of an allocation process flow, at the sub-account level. In this example, it is still Month 3, Day 15. In this case, after the daily term deposit expiration interest post process, the investment caps for the Bank 001 term deposit sub-account are set to zero. In particular, since it is the end of the term of the term deposit, the money in the term deposit sub-account must be liquidated/withdrawn and moved somewhere else.

In example 10, the allocation process reshuffles bank account balances by withdrawing/liquidating $250,000.00 from Bank 001 term deposit sub-account and depositing $250,000.00 in the Bank 002 (safety bank) MMDA sub-account.

Accordingly, after allocation processing, Bank 001 term deposit sub-account has a principal balance of $0, Bank 002 (safety bank) MMDA sub-account has a principal balance of $500,462.33 (previous balance plus $250,000 balance of bank 001), and Bank 003 MMDA sub-account has a principal balance of $250,000. Notwithstanding the liquidation of the Bank 001 term deposit sub-account, the $51.37 interest accrued in the Bank 001 term deposit sub-account still needs to be taken care of, in a process that will described more fully below.

### Example 11

Example 11 is an example of an interest post process, at a total customer account level. In this example, it is assumed that it is the end of Month 3.

At the end of month 3, the customer (aggregate) account has month-to-date (MTD) earnings of $308.22 that post to the customer account principal balance.

Thus, before the interest post process, the customer account has a principal balance of $750,462.33 and MTD accrued interest of $308.22. The interest post process simply adds the interest to the customer account balance. thus, after the interest post process, the customer account has a principal balance of $750,770.55 and MTD accrued interest of $0.

### Example 12

Example 12 is for describing an interest post-process flow at the bank sub-account level, again at the end of Month 3. As mentioned in Example 10, the Bank 001 term deposit sub-account, although liquidated earlier in the month, still has remaining $51.37 representing customer interest held past term. Accordingly, from the Bank 001 term deposit sub-account, a difference between the interest held past term and any prepaid interest for this month is added to Bank 002 (safety bank) MMDA sub-account. In this case, since there is no prepaid interest for this month, the $51.37 interest held past held past term is simply added to the safety bank.

Meanwhile, Bank 002 MMDA bank sub-account has accrued interest of $154.11 and Bank 003 MMDA bank sub-account has accrued interest of $102.74, which are both simply added to the corresponding MMDA balances.

Thus, at the end of the interest posting process, Bank 001 term deposit sub-account has a principal balance of $0, Bank 002 (safety bank) MMDA sub-account has a principal balance of $500,667.81 (previous balance plus $51.37 from bank 001 and $154.11 of its own accrued interest), and Bank 003 MMDA sub-account has a principal balance of $250,102.74 (previous balance plus MTD accrued interest).

### Example 13

Example 13 is for describing an allocation process flow at the sub-account level, still at the end of Month 3. As with the previous allocations, Example 13 describes reallocating in order to account for, e.g., FDIC insurance limits. In this example, it can be assumed that the FDIC insurance limit for Bank 003 MMDA sub-account is $250,000. At the end of Example 3 (the interest posting process), Bank 003 MMDA sub-account principal balance is again $250,102.74, which is again over the FDIC insurance limit.

Thus, in Example 13, with respect to maintaining a fixed sub-account balance and account insurance limit at Bank 003, an allocation process reshuffles bank account balances by withdrawing $102.74 from Bank 003 MMDA sub-account and depositing the $102.74 in the Bank 002 (safety bank) MMDA sub-account.

Accordingly, after allocation processing, Bank 001 term deposit sub-account has a principal balance of $0, Bank 002 (safety bank) MMDA sub-account has a principal balance of $500,770.55, and Bank 003 MMDA sub-account has a principal balance of $250,000.

### IV. Device

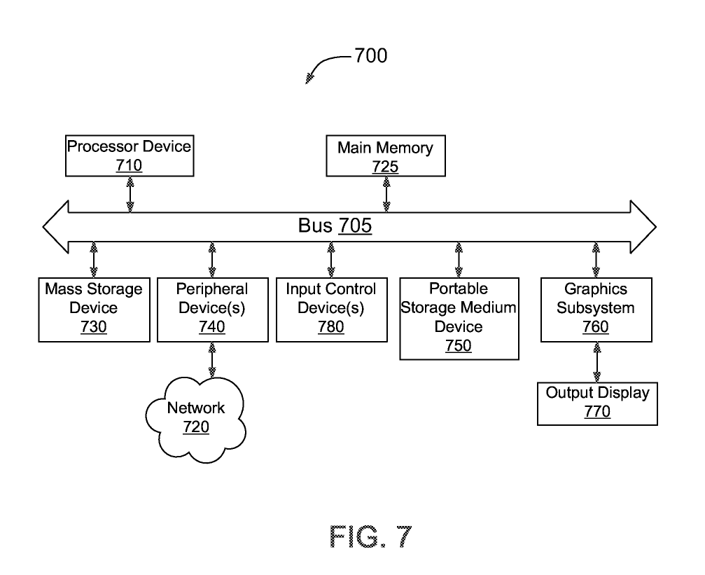

FIG. 7 is a block diagram of a general and/or special purpose computer 700, in accordance with some of the example embodiments of the invention. The computer 700 may be, for example, a user device, a user computer, a client computer and/or a server computer, among other things.

The computer 700 may include without limitation a processor device 710, a main memory 725, and an interconnect bus 705. The processor device 710 may include without limitation a single microprocessor, or may include a plurality of microprocessors for configuring the computer 700 as a multi-processor system. The main memory 725 stores, among other things, instructions and/or data for execution by the processor device 710. The main memory 725 may include banks of dynamic random access memory (DRAM), as well as cache memory.

The computer 700 may further include a non-transitory mass storage device 730, peripheral device(s) 740, non-transitory portable storage medium device(s) 750, input control device(s) 780, a graphics subsystem 760, and/or an output display 770. For explanatory purposes, all components in the computer 700 are shown in FIG. 7 as being coupled via the bus 705. However, the computer 700 is not so limited. Devices of the computer 700 may be coupled via one or more data transport means. For example, the processor device 710 and/or the main memory 725 may be coupled via a local microprocessor bus. The mass storage device 730, peripheral device(s) 740, portable storage medium device(s) 750, and/or graphics subsystem 760 may be coupled via one or more input/output (I/O) buses. The mass storage device 730 may be a nonvolatile storage device for storing data and/or instructions for use by the processor device 710. The mass storage device 730 may be implemented, for example, with a magnetic disk drive or an optical disk drive. In a software embodiment, the mass storage device 730 is configured for loading contents of the mass storage device 730 into the main memory 725.

The portable storage medium device 750 operates in conjunction with a nonvolatile portable storage medium, such as, for example, a compact disc read only memory (CD-ROM), to input and output data and code to and from the computer 700. In some embodiments, the software for storing text records may be stored on a portable storage medium, and may be inputted into the computer 700 via the portable storage medium device 750. The peripheral device(s) 740 may include any type of computer support device, such as, for example, an input/output (I/O) interface configured to add additional functionality to the computer 700. For example, the peripheral device(s) 740 may include a network interface card for interfacing the computer 700 with a network 720.

The input control device(s) 780 provide a portion of the user interface for a user of the computer 700. The input control device(s) 780 may include a keypad and/or a cursor control device. The keypad may be configured for inputting alphanumeric characters and/or other key information. The cursor control device may include, for example, a mouse, a trackball, a stylus, and/or cursor direction keys. In order to display textual and graphical information, the computer 700 may include the graphics subsystem 760 and the output display 770. The output display 770 may include a cathode ray tube (CRT) display and/or a liquid crystal display (LCD). The graphics subsystem 760 receives textual and graphical information, and processes the information for output to the output display 770.

Each component of the computer 700 may represent a broad category of a computer component of a general and/or special purpose computer. Components of the computer 700 are not limited to the specific implementations provided here.

### V. Computer Readable Medium Implementation

The example embodiments described above such as, for example, the systems and procedures depicted in or discussed in connection with FIGS. 1 to 7, or any part or function thereof, may be implemented by using hardware, software or a combination of the two. The implementation may be in one or more computers or other processing systems. While manipulations performed by these example embodiments may have been referred to in terms commonly associated with mental operations performed by a human operator, no human operator is needed to perform any of the operations described herein. In other words, the operations may be completely implemented with machine operations. Useful machines for performing the operation of the example embodiments presented herein include general purpose digital computers or similar devices.

Portions of the example embodiments of the invention may be conveniently implemented by using a conventional general purpose computer, a specialized digital computer and/or a microprocessor programmed according to the teachings of the present disclosure, as is apparent to those skilled in the computer art. Appropriate software coding may readily be prepared by skilled programmers based on the teachings of the present disclosure.

Some embodiments may also be implemented by the preparation of application-specific integrated circuits, field programmable gate arrays, or by interconnecting an appropriate network of conventional component circuits.

Some embodiments include a computer program product. The computer program product may be a non-transitory storage medium or media having instructions stored thereon or therein which can be used to control, or cause, a computer to perform any of the procedures of the example embodiments of the invention. The storage medium may include without limitation a floppy disk, a mini disk, an optical disc, a Blu-ray Disc, a DVD, a CD-ROM, a micro-drive, a magneto-optical disk, a ROM, a RAM, an EPROM, an EEPROM, a DRAM, a VRAM, a flash memory, a flash card, a magnetic card, an optical card, nanosystems, a molecular memory integrated circuit, a RAID, remote data storage/archive/warehousing, and/or any other type of device suitable for storing instructions and/or data.

Stored on any one of the computer readable medium or media, some implementations include software for controlling both the hardware of the general and/or special computer or microprocessor, and for enabling the computer or microprocessor to interact with a human user or other mechanism utilizing the results of the example embodiments of the invention. Such software may include without limitation device drivers, operating systems, and user applications. Ultimately, such computer readable media further includes software for performing example aspects of the invention, as described above.

Included in the programming and/or software of the general and/or special purpose computer or microprocessor are software modules for implementing the procedures described above.

While various example embodiments of the invention have been described above, it should be understood that they have been presented by way of example, and not limitation. It is apparent to persons skilled in the relevant art(s) that various changes in form and detail can be made therein. Thus, the disclosure should not be limited by any of the above described example embodiments, but should be defined only in accordance with the following claims and their equivalents.

In addition, it should be understood that the figures are presented for example purposes only. The architecture of the example embodiments presented herein is sufficiently flexible and configurable, such that it may be utilized and navigated in ways other than that shown in the accompanying figures.

Further, the purpose of the Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the example embodiments presented herein in any way. It is also to be understood that the procedures recited in the claims need not be performed in the order presented.

What is claimed is:

1. A bank product server for determining an allocation of funds to multiple accounts, the server comprising at least one processor communicatively coupled to a communication network, wherein the processor is configured to:
receive information about financial transactions from multiple sources over the communication network;
aggregate the information to determine a total amount of allocatable funds, wherein the allocatable funds include posted interest associated with the allocatable funds;
determine respective deposit rules for each of the multiple accounts, wherein the multiple accounts include sub-accounts at the same bank, and wherein the deposit rules include a limit based on FDIC insurance; and
determine the allocation of the allocatable funds to the multiple accounts based on a priority hierarchy set to the multiple accounts, wherein funds are allocated such that each account or sub-account in the priority hierarchy is filled to its respective limit according to the respective deposit rules until the total amount of allocatable funds is allocated.

2. The bank product server according to claim 1, wherein the server determines the allocation of funds a second time before transmitting instructions for updating the respective multiple accounts.

3. The bank product server according to claim 1, wherein the respective deposit rules include rules relating to paying interest on the respective account.

4. The bank product server according to claim 1, wherein the server further verifies that the posted interest determined to be allocated across the multiple accounts corresponds to an amount of interest that would be posted on the total amount of allocatable funds.

5. The bank product server according to claim 1, wherein the respective deposit rules include a limit for what percentage of an account can be deposited as a term deposit.

6. The bank product server according to claim 1, wherein the priority hierarchy includes a hierarchy for the sub-accounts at the same bank.

7. The bank product server according to claim 1, wherein the sub-accounts include different bank accounts of any type at the bank.

8. The bank product server according to claim 7, wherein one of the accounts is a certificate of deposit, and wherein posted interest on the certificate of deposit is pre-paid and allocated in the course of multiple payments over multiple periods before the payment date of the certificate of deposit.

9. The bank product server according to claim 1, wherein the processor is further configured to designate a safety bank for storing excess allocatable funds which can not be allocated to any other of the multiple accounts.

10. The bank product server according to claim 9, wherein the excess allocatable funds are stored in the safety bank in a case that deposits in each of the multiple accounts have reached an FDIC insurance limit.

11. The bank product server according to claim 1, wherein one of the accounts is a certificate of deposit, and wherein posted interest on the certificate of deposit is post-paid by a broker to a client after the payment date of the certificate of deposit.

12. A method for determining an allocation of funds to multiple accounts, the method comprising:
performing, by at least one processor, the steps of:
receiving information about financial transactions from multiple sources over the communication network;
aggregating the information to determine a total amount of allocatable funds, wherein the allocatable funds include posted interest associated with the allocatable funds;
determining respective deposit rules for each of the multiple accounts, wherein the multiple accounts include sub-accounts at the same bank, and wherein the deposit rules include a limit based on FDIC insurance; and
determining the allocation of the allocatable funds to the multiple accounts based on a priority hierarchy set to the multiple accounts, wherein funds are allocated such that each account or sub-account in the priority hierarchy is filled to its respective limit according to the respective deposit rules until the total amount of allocatable funds is allocated.

13. The method according to claim 12, wherein there is a determination of the allocation of funds a second time before transmitting instructions for updating the respective multiple accounts.

14. The method according to claim 12, wherein the respective deposit rules include rules relating to paying interest on the respective account.

15. The method according to claim 12, wherein the server further verifies that the posted interest determined to be allocated across the multiple accounts corresponds to an amount of interest that would be posted on the total amount of allocatable funds.

16. The method according to claim 12, wherein the respective deposit rules include a limit for what percentage of an account can be deposited as a term deposit.

17. The method according to claim 12, wherein the priority hierarchy includes a hierarchy for the sub-accounts at the same bank.

18. The method according to claim 12, wherein the sub-accounts include different bank accounts of any type at the bank.

19. The method according to claim 18, wherein one of the accounts is a certificate of deposit, and wherein posted interest on the certificate of deposit is pre-paid and allocated in the course of multiple payments over multiple periods before the payment date of the certificate of deposit.

20. The method according to claim 12, wherein the processor is further configured to designate a safety bank for storing excess allocatable funds which can not be allocated to any other of the multiple accounts.

21. The method according to claim 20, wherein the excess allocatable funds are stored in the safety bank in a case that deposits in each of the multiple accounts have reached an FDIC insurance limit.

22. The method according to claim 12, wherein one of the accounts is a certificate of deposit, and wherein posted interest on the certificate of deposit is post-paid by a broker to a client after the payment date of the certificate of deposit.

23. A non-transitory computer-readable medium having stored thereon sequences of instructions for determining an allocation of funds to multiple accounts, the sequences of instructions including instructions, which, when executed by a processor, cause the processor to perform:
receiving information about financial transactions from multiple sources over the communication network;
aggregating the information to determine a total amount of allocatable funds, wherein the allocatable funds include posted interest associated with the allocatable funds;
determining respective deposit rules for each of the multiple accounts, wherein the multiple accounts include sub-accounts at the same bank, and wherein the deposit rules include a limit based on FDIC insurance; and
determining the allocation of the allocatable funds to the multiple accounts based on a priority hierarchy set to the multiple accounts, wherein funds are allocated such that each account or sub-account in the priority hierarchy is filled to its respective limit according to the respective deposit rules until the total amount of allocatable funds is allocated.

24. The computer-readable medium according to claim 23, wherein there is a determination of the allocation of funds a second time before transmitting instructions for updating the respective multiple accounts.

25. The computer-readable medium according to claim 23, wherein the respective deposit rules include rules relating to paying interest on the respective account.

26. The computer-readable medium according to claim 23, wherein the processor further verifies that the posted interest determined to be allocated across the multiple accounts corresponds to an amount of interest that would be posted on the total amount of allocatable funds.

27. The computer-readable medium according to claim 23, wherein the respective deposit rules include a limit for what percentage of an account can be deposited as a term deposit.

28. The computer-readable medium according to claim 23, wherein the priority hierarchy includes a hierarchy for the sub-accounts at the same bank.

29. The computer-readable medium according to claim 23, wherein the sub-accounts include different bank accounts of any type at the bank.

30. The computer-readable medium according to claim 29, wherein one of the accounts is a certificate of deposit, and wherein posted interest on the certificate of deposit is pre-paid and allocated in the course of multiple payments over multiple periods before the payment date of the certificate of deposit.

31. The computer-readable medium according to claim 23, wherein the processor is further configured to designate a safety bank for storing excess allocatable funds which can not be allocated to any other of the multiple accounts.

32. The computer-readable medium according to claim 31, wherein the excess allocatable funds are stored in the safety bank in a case that deposits in each of the multiple accounts have reached an FDIC insurance limit.

33. The computer-readable medium according to claim 23, wherein one of the accounts is a certificate of deposit, and wherein posted interest on the certificate of deposit is post-paid by a broker to a client after the payment date of the certificate of deposit.

34. A server for receiving part or all of an allocation of funds to multiple accounts, the server comprising at least one processor communicatively coupled to a communication network, wherein the processor is configured to:
receive an allocation of allocatable funds over the network, wherein the allocation of allocatable funds is determined by:
receiving information about financial transactions from multiple sources over the communication network;
aggregating the information to determine a total amount of allocatable funds, wherein the allocatable funds include posted interest associated with the allocatable funds;
determining respective deposit rules for each of the multiple accounts, wherein the multiple accounts include sub-accounts at the same bank, and wherein the deposit rules include a limit based on FDIC insurance; and
determining the allocation of the allocatable funds to the multiple accounts based on a priority hierarchy set to the multiple accounts, wherein funds are allocated such that each account or sub-account in the priority hierarchy is filled to its respective limit according to the respective deposit rules until the total amount of allocatable funds is allocated.

35. The server according to claim 34, wherein there is a determination of the allocation of funds a second time before transmitting instructions to the server for updating the respective multiple accounts.

36. The server according to claim 34, wherein the respective deposit rules include rules relating to paying interest on the respective account.

37. The server according to claim 34, wherein the device further verifies that the posted interest determined to be allocated across the multiple accounts corresponds to an amount of interest that would be posted on the total amount of allocatable funds.

38. The server according to claim 34, wherein the respective deposit rules include a limit for what percentage of an account can be deposited as a term deposit.

39. The server according to claim 34, wherein the priority hierarchy includes a hierarchy for the sub-accounts at the same bank.

40. The server according to claim 34, wherein the sub-accounts include different bank accounts of any type at the bank.

41. The server according to claim 40, wherein one of the accounts is a certificate of deposit, and wherein posted interest on the certificate of deposit is pre-paid and allocated in the course of multiple payments over multiple periods before the payment date of the certificate of deposit.

42. The server according to claim 34, wherein a safety bank is designated for storing excess allocatable funds which can not be allocated to any other of the multiple accounts.

43. The server according to claim 42, wherein the excess allocatable funds are stored in the safety bank in a case that deposits in each of the multiple accounts have reached an FDIC insurance limit.

44. The server according to claim 34, wherein one of the accounts is a certificate of deposit, and wherein posted interest on the certificate of deposit is post-paid by a broker to a client after the payment date of the certificate of deposit.
